(19) United States
(12) Patent Application Publication
(10) Pub. No.: US 2017/0242498 A1
(43) Pub. Date: Aug. 24, 2017

(54) Passive Chopsticks Stylus System for Capacitive Touch Screens

(71) Applicant: Motorola Mobility LLC, Chicago, IL (US)

(72) Inventor: Mark F. Valentine, Kenosha, WI (US)

(21) Appl. No.: 15/051,144

(22) Filed: Feb. 23, 2016

(51) Int. Cl. G06F 3/0354; G06F 3/044

(52) U.S. Cl. CPC G06F 3/03545; G06F 3/044

(57) ABSTRACT

A method, chopstick stylus apparatus, and a chopstick stylus interfacing system provides both single stylus functionality and dual stylus functionality corresponding to specific touch screen interactions with the chopstick stylus apparatus. A dual stylus detection module (DSDM) executing on a processor of a touch screen computing device receives and/or causes the processor to receive input values that correspond to information representing touch screen interactions detected using a touch screen sensor. The DSDM determines, from the received input values, at least one matching signature from among a plurality of interaction signatures corresponding to different touch screen interactions that can be provided via a chopstick stylus apparatus. The DSDM is able to identify both individual stylus interactions and dual stylus interactions, based on a corresponding matching signature(s). The DSDM provides a response of the electronic device to the identified touch screen interactions based on the matching signature(s).

### BACKGROUND

1. Technical Field

The present disclosure generally relates to touch screen systems and in particular to styluses for use with touch screen systems.

2. Description of the Related Art

A large number of electronic devices that include a display are being designed with a touch screen interface. For example, many personal user devices, such as tablets, mobile phones, and laptops, provide a touch screen for use as both a visual output device and a tactile input device. One mechanism for interacting with the touch screen of these devices is a passive stylus. Passive styluses have become increasingly popular as the demand for devices having capacitive touch screens have increased exponentially. For example, passive stylus systems have proven popular with users because it allows for drawing of characters. However, it is difficult to perform two-finger gestures while holding a stylus. Additionally, there is a limit to the number of functions that can be performed with a traditional stylus.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates an example electronic device having a touch screen and within which various aspects of the disclosure can be implemented, according to one or more embodiments;

FIG. 2 illustrates a chopstick stylus apparatus, according to one or more embodiments;

FIG. 3 illustrates the chopstick stylus apparatus being held in a user's hand in open tip and closed tip orientations, according to one or more embodiments;

FIG. 4 illustrates a chopstick stylus apparatus that uses elastomeric connectors to activate the dual stylus mode, according to one or more embodiments;

FIG. 5 illustrates a chopstick stylus apparatus that uses a pair of diodes to activate the dual stylus mode, according to one or more embodiments;

FIG. 6 illustrates an interactive system of a touch screen and a chopstick-stylus apparatus, according to one or more embodiments;

FIG. 7 illustrates a series of interactions used to identify one or more dual-stylus touch screen gestures, according to one or more embodiments;

FIG. 8A illustrates a table providing detection signal information used to identify various types of touch screen interactions involving a chopstick stylus apparatus, according to one or more embodiments;

FIG. 8B illustrates a table providing a mapping of identified touch screen interactions involving a chopstick stylus apparatus to gesture definitions and functional responses/operations, according to one or more embodiments

FIG. 9 is a flow chart illustrating a method for identifying single stylus and dual stylus interactions based on an interaction signal signature detected within a touch screen and chopstick stylus system, according to one or more embodiments; and

FIG. 10 is a flow chart illustrating a method for performing responsive gestures within a GUI based on identifying single stylus and dual stylus interactions, according to one or more embodiments.

### DETAILED DESCRIPTION

The illustrative embodiments provide a method, chopstick stylus apparatus, and a chopstick stylus interfacing system that provides both single stylus functionality and dual stylus functionality corresponding to specific touch screen interactions with the chopstick stylus apparatus. A dual stylus detection module (DSDM) executing on a processor of a touch screen computing device receives and/or causes the processor to receive input values that correspond to information representing touch screen interactions detected using a touch screen sensor. The DSDM determines, from the received input values, at least one matching signature from among a plurality of interaction signatures corresponding to different touch screen interactions that can be provided via a chopstick stylus apparatus. The DSDM is able to identify both individual stylus interactions and dual stylus interactions, based on a corresponding matching signature(s). The DSDM provides a response of the electronic device to the identified touch screen interactions based on the matching signature(s).

According to one embodiment, the method includes identifying one or more interactions (i.e., touches and/or movements) within one or more regions of a graphical user interface (GUI) displayed on the touch screen. The DSDM identifies at least one matching gesture corresponding to the identified one or more interactions associated with the target region of the GUI. With the matching gesture identified, the DSDM performs interactive functions within the electronic device, which can involve providing corresponding changes to the GUI.

In the following detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

Those of ordinary skill in the art will appreciate that the hardware, firmware/software utility, and software components and basic configuration thereof depicted in the following figures may vary. For example, the illustrative components of IHS 100/400 are not intended to be exhaustive, but rather are representative to highlight some of the components that are utilized to implement certain aspects of the described embodiments. For example, different configurations of an IHS may be provided, containing other devices/components, which may be used in addition to or in place of the hardware depicted, and may be differently configured. The depicted example is not meant to imply architectural or other limitations with respect to the presently described embodiments and/or the general invention.

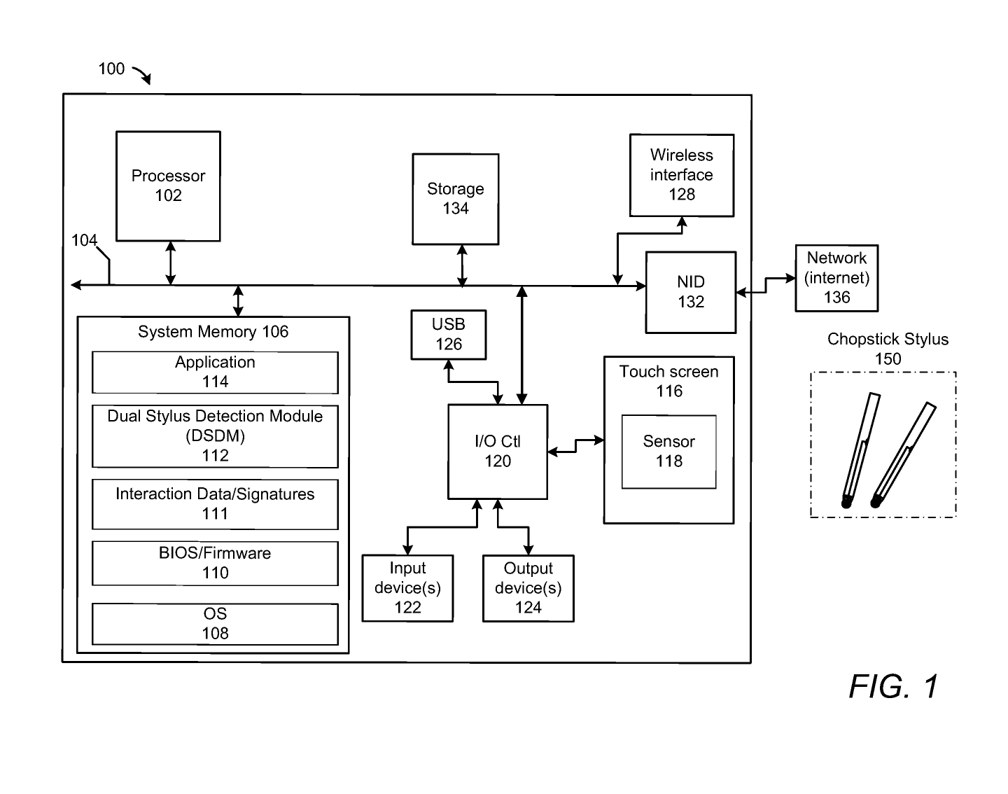

FIG. 1 illustrates a block diagram representation of an example electronic device 100 having a touch screen and within which one or more of the described features of the various embodiments of the disclosure can be implemented. Electronic device 100 can be a data processing system, laptop, mobile device, tablet, instrumentation device, or other similar electronic device that includes a touch screen and generally supports receipt and processing of tactile inputs via a touch screen stylus.

Referring to FIG. 1, example electronic device 100 includes one or more processor(s) 102 coupled to system memory 106 via system interconnect 104. System interconnect 104 can be interchangeably referred to as a system bus, in one or more embodiments. Also coupled to system interconnect 104 is storage 134 within which can be stored one or more software and/or firmware modules and/or data (not specifically shown). In one embodiment, storage 134 can be a hard drive or a solid state drive. The one or more software and/or firmware modules within storage 134 can be loaded into system memory 106 during operation of electronic device 100. As shown, system memory 106 can include therein a plurality of modules, including operating system (O/S) 108, Basic Input/Output System (BIOS)/firmware 110, Dual Stylus Detection Module (DSDM) 112, and application(s) 114. In addition, system memory 106 includes data and/or information for use by DSDM 112, specifically interaction data and signatures 111. The various software and/or firmware modules have varying functionality when their corresponding program code is executed by processor(s) 102 or other processing devices within electronic device 100.

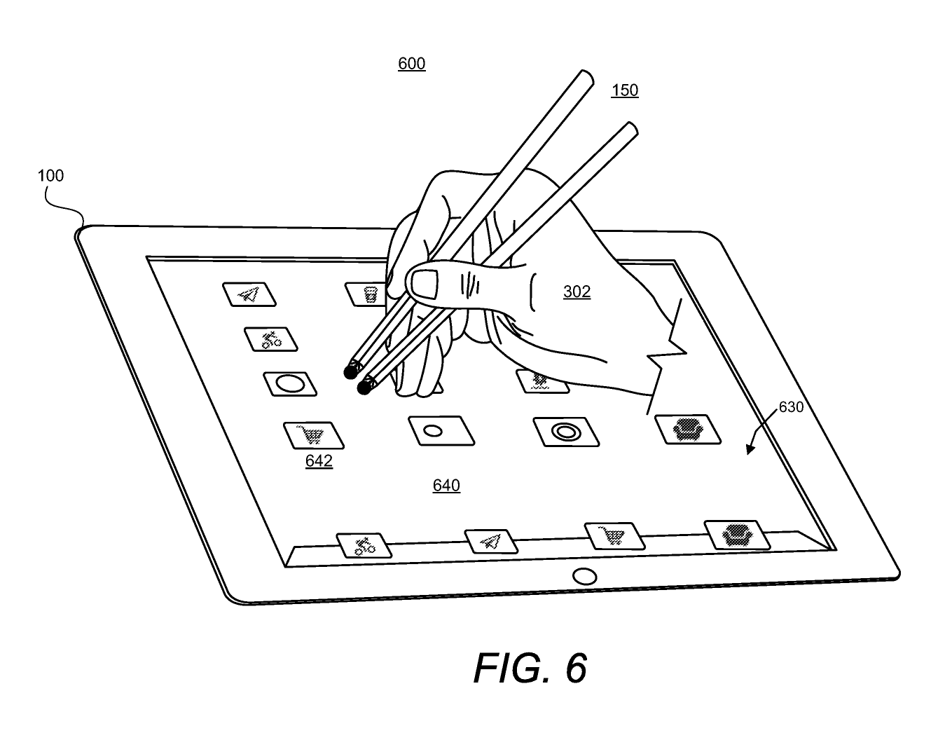

Electronic device 100 further includes one or more input/output (I/O) controllers 120, which support connection to, and processing of, signals from one or more connected input device(s) 122, such as a keyboard, mouse, touch screen, or microphone. I/O controllers 120 also support connection to, and forwarding of, output signals to one or more connected output device(s) 124, such as a monitor or display device or audio speaker(s). According to one aspect of the disclosure, the monitor or display device of electronic device 100 is a touch screen device, which is illustrated as touch screen 116. Touch screen 116 is communicatively (and electrically) coupled to I/O controller 120. As illustrated, touch screen 116 includes touch screen sensor 118. Any of a number of different touch screen technologies can be implemented within the described embodiments, so long as configurable to capture different types of signals when a stylus is utilized to interface with touch screen 116. In the illustrated and describe embodiments, the interfacing with touch screen 116 is provided by chopstick stylus apparatus 150. In one embodiment, chopstick stylus apparatus 150 can be packaged as a periphery of a touch screen electronic devices. However, in alternate embodiments, chopstick stylus apparatus 150 can be an off-the-shelf component, sold as a separate peripheral device for enhanced touch screen interfacing. Within the descriptions, the combination of a touch screen and a chopstick stylus apparatus are occasionally referenced as touch screen and chopstick stylus system, as provided by FIG. 6.

Electronic device 100 includes universal serial bus (USB) 126 which is coupled to I/O controller 120. Additionally, in one or more embodiments, wireless interface 128 can be associated with electronic device 100. Wireless interface 128 can be used to provide Wi-Fi, Bluetooth and/or Near Field Communication (NFC) capabilities to electronic device 100. When electronic device 100 is a cellular phone, electronic device 100 also includes electronic hardware that supports cellular communications, such as a digital signal processor, one or more transceivers, and one or more antennae. These specific features of a cellular phone implementation of electronic device 100 can be configured to the specific use of chopstick stylus apparatus 150, in one embodiment.

Electronic device 100 also comprises a network interface device (NID) 132. NID 132 enables electronic device 100 to communicate and/or interface with other devices, services, and components that are located external to electronic device 100. These devices, services, and components can interface with electronic device 100 via an external network, such as example network 136, using one or more communication protocols.

Network 136 can be a wired local area network, a wireless wide area network, wireless personal area network, wireless local area network, and the like, and the connection to and/or between network 136 and electronic device 100 can be wired or wireless or a combination thereof. For purposes of discussion, network 136 is indicated as a single collective component for simplicity. However, it is appreciated that network 136 can comprise one or more direct connections to other devices as well as a more complex set of interconnections as can exist within a wide area network, such as the Internet. In at least one embodiment, firmware or applications, such as DSDM 112 can be downloaded from a server located on network 136 to electronic device 100 to provide driver support for the additional dual stylus functionality provided by chopstick stylus apparatus 150.

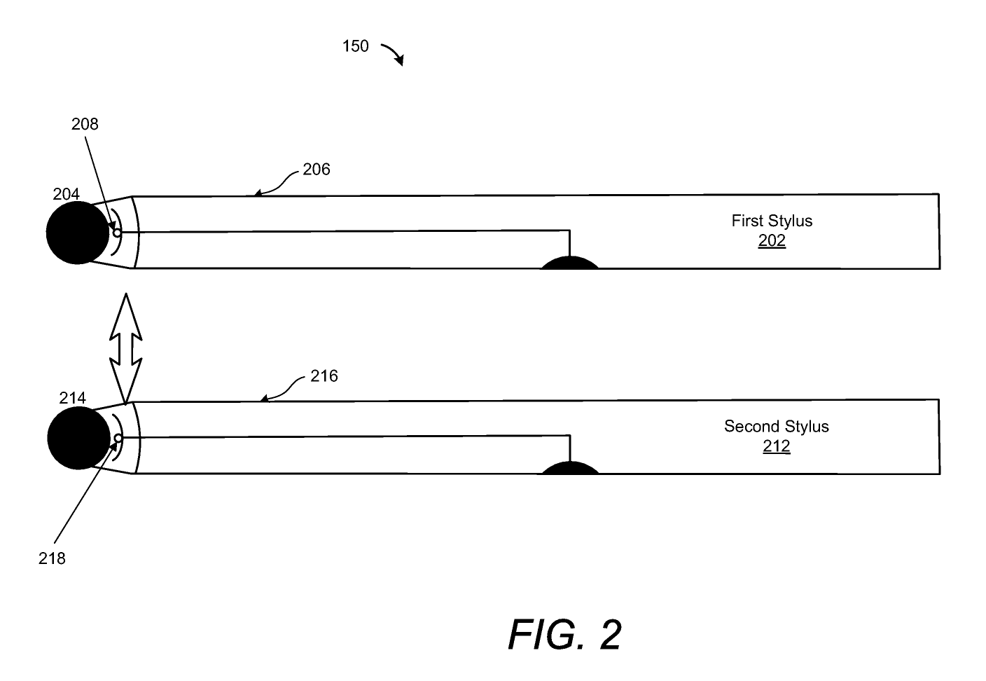

With specific reference now to FIG. 2, there is depicted chopstick stylus apparatus 150, according to one or more embodiments. Chopstick stylus apparatus 150 comprises first stylus 202 having first tip 204, first barrel 206, and first switch 208 that enables first tip 204 to be communicatively coupled to first barrel 206. Chopstick stylus apparatus 150 also comprises second stylus 212 having second tip 214, second barrel 216, and second switch 218 that enables second tip 214 to be communicatively coupled to second barrel 216.

In one embodiment, first switch 208 is capacitively coupled to first tip 204, and second switch 218 is capacitively coupled to second tip 214. Each of first switch 208 and second switch 218 is activated by contact being made between first tip 204 and second tip 214. The contact occurs in response to first tip 204 and second tip 214 being moved toward each other. First tip 204 is communicatively coupled to first barrel 206 of first stylus 202 in response to first switch 208 being activated. Similarly, second tip 214 is communicatively coupled to second barrel 216 of second stylus 212 in response to second switch 218 being activated.

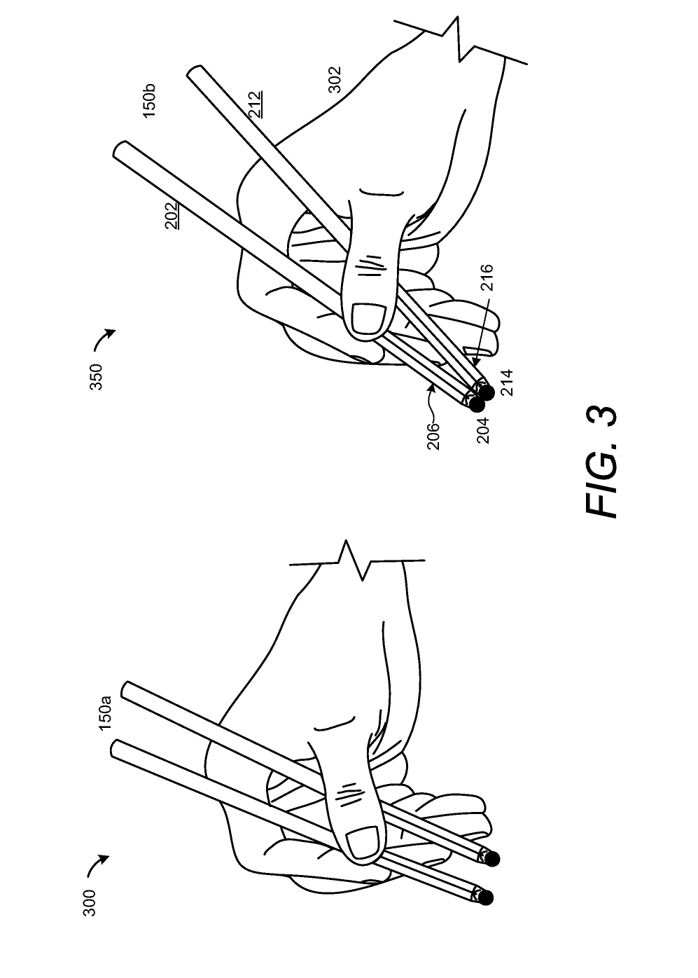

FIG. 3 illustrates two views of chopstick stylus apparatus 150 being held in a user's hand in open position 300 and closed position 350, respectively, according to one or more embodiments. As depicted, chopstick stylus apparatus 150 is being held in a user's hand 302 in a manner similar to that by which chopsticks commonly used as eating utensils are handled. Chopstick stylus apparatus 150 comprises first stylus 202 having first tip 204 and first barrel 206, which can be grounded via user's hand 302. Additionally, chopstick stylus apparatus 150 also comprises second stylus 212 having second tip 214 and second barrel 216, which can be grounded via user's hand 302.

As illustrated, the user can manipulate chopstick stylus apparatus 150 from a first position, open position 300, with the first and second tips 204 and 214 spaced apart from each other, to second position, closed position 350, with physical contact provided between first tip 204 and second tip 214 of respective first and second styluses 202 and 212. When contact is made between first tip 204 and second tip 214, first switch 208 is activated, causing first tip 204 to become communicatively coupled to first barrel 206. Concurrently, second switch 218 is activated, causing second tip 214 to be communicatively coupled to second barrel 216.

According to one aspect, first tip 204 and second tip 214 are both conductive. As described herein the term “closed stylus interaction” are used to indicate an interaction performed by the chopstick stylus apparatus 150 while there is electrical and/or physical contact between the first and second conductive stylus tips. The term “individual” as in “individual stylus interactions” is used to indicate operations where there is either a single stylus being utilized or when there is spatial separation (i.e., no contact or an open position) between the first and second conductive stylus tips.

Referring again to FIG. 3, first stylus 202 and second stylus 212 are operable together by a user in open position 300 to provide single stylus functionality (150a). In open position 300, first and second switches 208, 218 are not activated. Alternatively, first stylus 202 and second stylus 212 are operable together by a user in closed position 350 to provide dual stylus functionality (150b). In this embodiment, dual stylus functionality is triggered when and/or while first and second switches are activated, and the specific dual stylus operations are triggered based on user manipulation.

According to one embodiment, the single stylus mode is detected in response to individual stylus interactions which include open stylus interactions involving a pair of individual stylus and/or touch screen interactions in which the first stylus and the second stylus are separated by at least a threshold spatial separation distance. In one aspect, individual stylus interactions generate first, lower signal levels that are detected by the touch screen sensor. The touch screen sensor transmits these detected signal levels along with positioning and other interaction type data to the processor of the electronic device for processing. Additionally, the dual stylus mode is activated in response to the first switch and the second switch being activated. The dual stylus mode is detected by the touch screen sensor in response to closed position touch screen stylus interactions. As one aspect, dual stylus interactions while the apparatus is in the closed position generate second, higher signal levels. The corresponding data values for these higher signal levels are captured by touch screen sensor and transmitted along with position, movement, and interaction type data to the processor for processing.

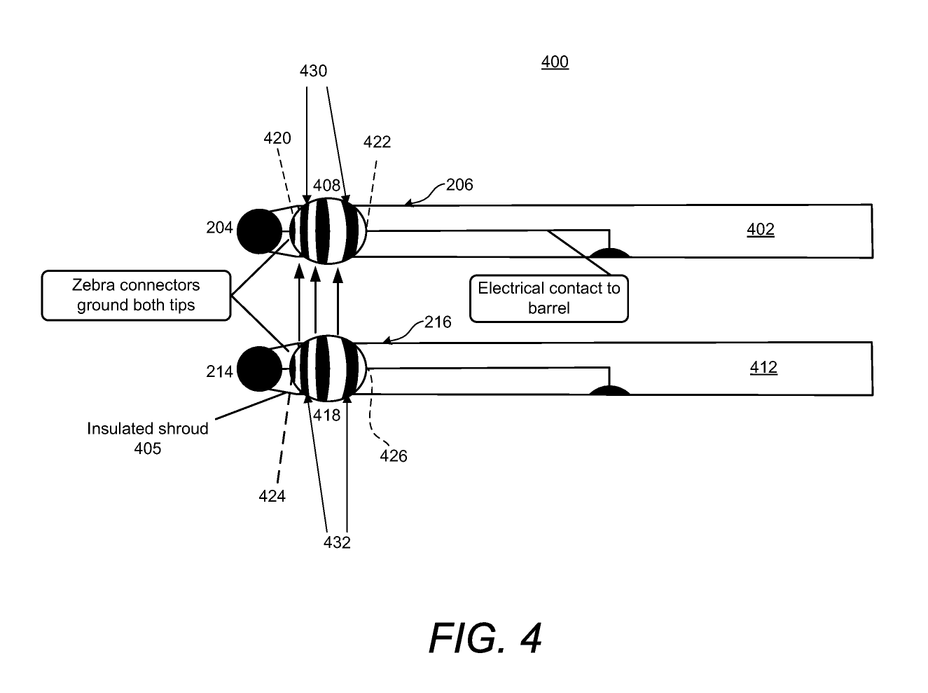

FIG. 4 illustrates an embodiment of chopstick stylus apparatus 400 configured with elastomeric connectors, which are utilized to activate the dual stylus mode. Chopstick stylus apparatus 400 comprises first stylus 402 having first tip 204 and first barrel 206. Chopstick stylus apparatus also comprises second stylus 412 having second tip 214 and second barrel 216.

Additionally, chopstick stylus apparatus 400 includes a first switch that is implemented via first elastomeric connector 408, which is capacitively coupled by first connector node 420 to first tip 204. First elastomeric connector 408 is also electrically coupled by second connector node 422 to first barrel 206. Similarly, the second switch is implemented via second elastomeric connector 418 that is capacitively coupled by third connector node 424 to second tip 214. Second elastomeric connector 418 is also electrically coupled by fourth connector node 426 to second barrel 216. First elastomeric connector 408 comprises exposed first conductive layers 430. Second elastomeric connector 418 comprises exposed second conductive layers 432. According to one aspect, first elastomeric connector 408 is a complementary component of second elastomeric connector 418. In response to contact being made between first conductive layers 430 and second conductive layers 432, first connector node 420 becomes electrically coupled to second connector node 422 and first barrel 206, and third connector node 424 becomes electrically coupled to fourth connector node 426 and second barrel 216. The dual stylus mode is activated in response to the electrical coupling involving respective connector nodes.

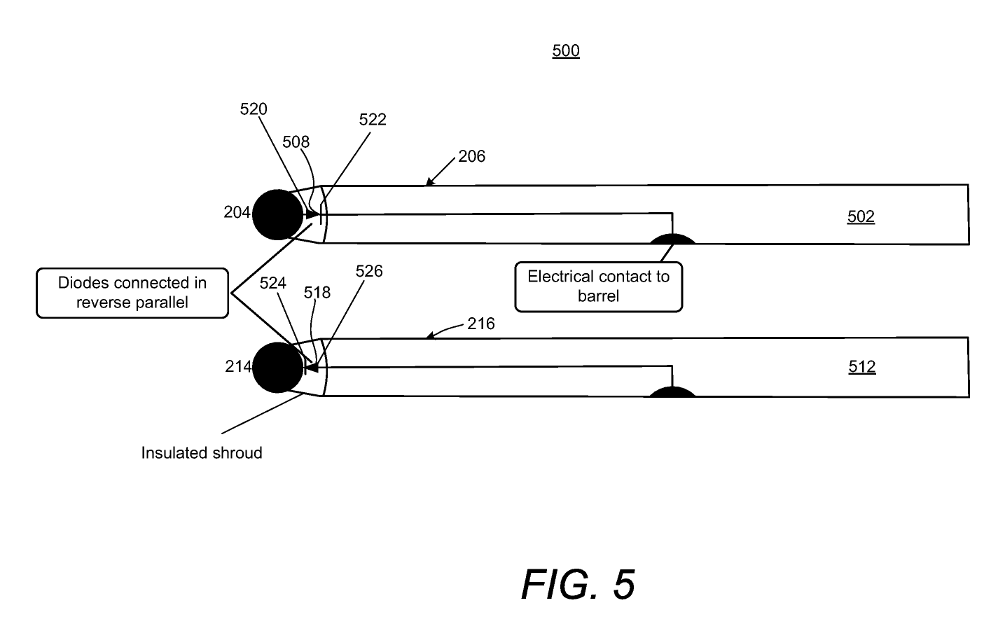

FIG. 5 illustrates a different embodiment of chopstick stylus apparatus, which uses a pair of diodes to activate the dual stylus mode. Chopstick stylus apparatus 500 comprises first stylus 502 having first tip 204 and a first barrel 206. Chopstick stylus apparatus 500 also comprises second stylus 512 having second tip 214 and second barrel 216.

Chopstick stylus apparatus 500 includes a first switch that is implemented via first diode 508, which is electrically coupled by first positive electrode or anode 520 to first tip 204 and which is electrically coupled by first negative electrode or cathode 522 to first barrel 206. A second switch is implemented via second diode 518, which is electrically coupled by second negative electrode or cathode 524 to second tip 214 and which is electrically coupled by second positive electrode or anode 526 to second barrel 216. To enable operation as a rectifier diode, first diode 508 and second diode 518 are collectively arranged in a reverse parallel configuration, providing rectifier diode functionality when the first switch and second switch are activated by contact being made between the first and second tips 204, 214. Dual stylus mode is activated in response to the first switch and the second switch being activated, which occurs when contact is made between the first and second tips.

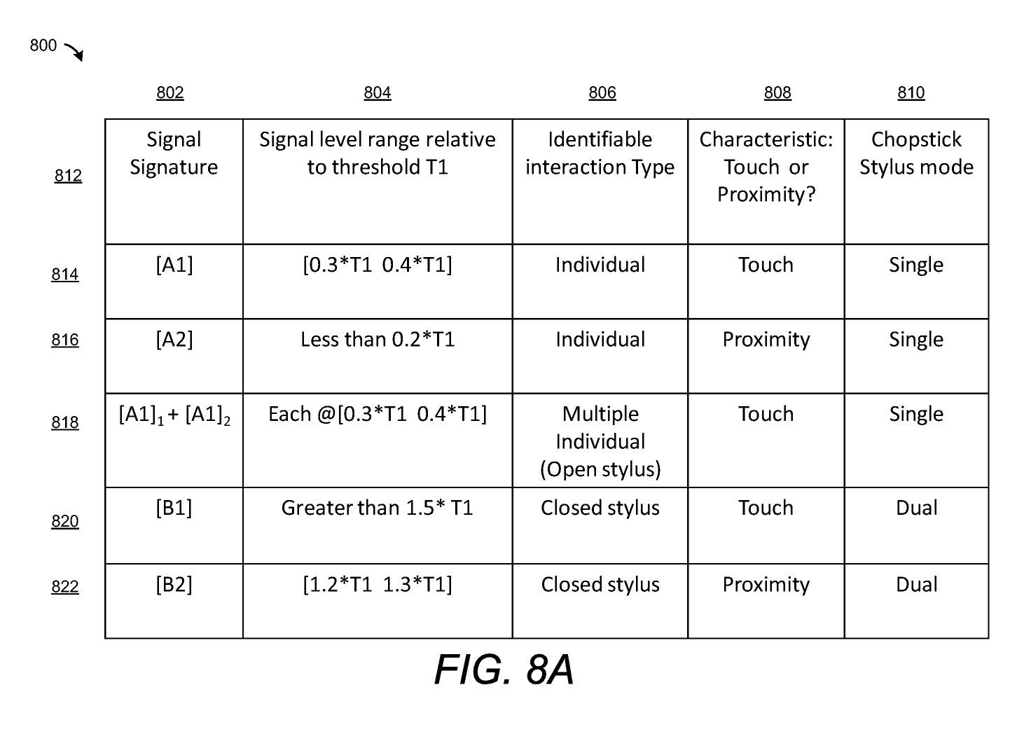

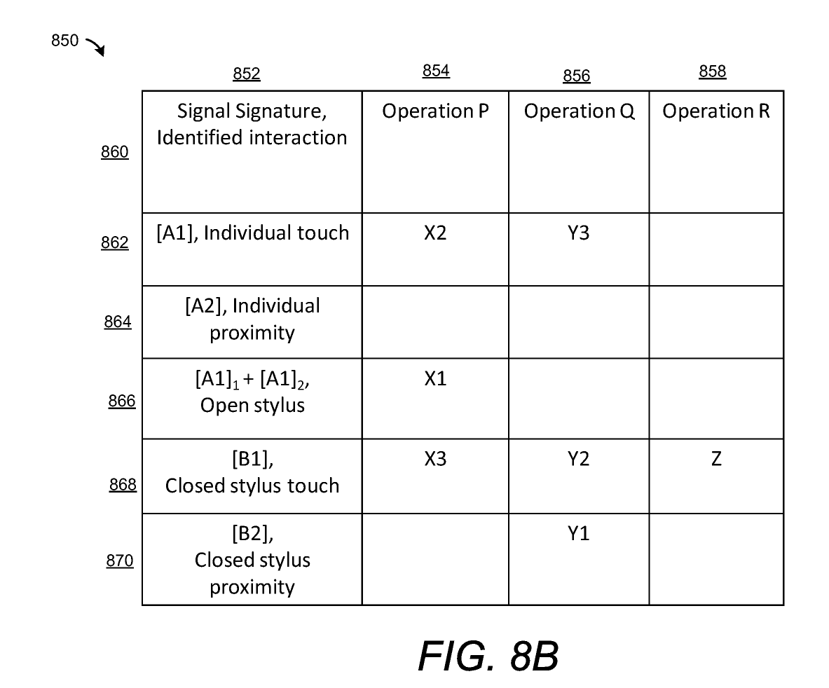

FIG. 6 illustrates touch screen and chopstick-stylus (TSCS) system 600, according to one or more embodiments. Touch screen and chopstick-stylus system 600 comprises electronic device 100 and chopstick stylus apparatus 150 which is held in a user's hand 302. FIG. 6 is described with reference to components presented within FIG. 1. Electronic device 100 comprises touch screen 116 having touch screen surface 630 and which displays graphical user interface (GUI) 640 which further comprises a number of interactive control elements, such as control element 642. Electronic device 100 also comprises a processor 102 (FIG. 1), a capacitive touch screen display 118 (FIG. 1) and a dual stylus detection module (DSDM) 112 executing on processor 102. Capacitive touch screen display 118 is communicatively coupled to processor 102 and is configured to display GUI 640 and also to detect touch and proximity interactions with chopstick stylus apparatus 150. Capacitive touch screen display 116 comprises touch screen sensor 118 (FIG. 1) that (i) collects information corresponding to detected touch and proximity interactions by chopstick stylus apparatus 150 and (ii) forwards the information to processor 102. DSDM 112 enables processor 102 and electronic device 100 to support both single stylus and dual stylus functions of chopstick stylus apparatus 150. DSDM 112, executing on processor 102, receives and/or causes the processor to receive input values from the information representing the touch screen interactions. DSDM 112 determines, from the received input values, at least one matching signature from among a plurality of interaction signatures (such as presented in FIGS. 8A-8B) corresponding to different touch screen interactions that can be provided via chopstick stylus apparatus 150. DSDM 112 enables a response of electronic device 100 to at least one identified touch screen interaction based on the at least one matching signature.

In one embodiment, input values received from touch screen sensor 119 by DSDM 112/processor 102 comprises location information identifying a display region at which an interaction is detected. Based on the identified display region, DSDM 112 identifies at least one control element 642 within GUI 640, which control element 642 is being targeted by at least one identified interaction with the touch screen. The identified display region substantially coincides with a segment of the display corresponding to a target control element, such as control element 642, being manipulated by the user via chopstick stylus apparatus 150. DSDM 112 then identifies at least one matching gesture corresponding to the at least one identified interaction within the identified display region. DSDM 112, in providing the response of the electronic device, performs interactive functions that include providing corresponding changes to GUI 640 of touch screen display based on the matching gesture(s).

According to one or more aspects, DSDM 112 identifies a type of interaction corresponding to received input values from touch screen sensor 119 based on at least one of a signal level and an interaction signature corresponding to the received input values. In one embodiment, the matching signature(s) can include a first matching signature, and DSDM 112 determines that the first matching signature represents a first closed stylus interaction caused by a first contact being made between the first stylus and the second stylus. The first contact activates the dual stylus mode, which enables chopstick stylus apparatus 150 to be operable to provide at least one closed stylus interaction having an identifiable signature associated with the activated dual stylus mode.

According to one embodiment, the matching signature(s) can include an initial matching signature. DSDM 112 determines from the initial matching signature that a touch event has occurred, which event is identified as an individual touch interaction(s) involving at least one of the first stylus and the second stylus. Individual touch interactions include the open stylus position involving a pair of identifiable individual stylus interactions. An individual touch interaction is identifiable via the individual stylus mode. The dual stylus interaction mode is triggered by contact between first tip 204 and second tip 214 and remains activated while contact is maintained between first tip 204 and the second tip 214 and/or until the tips are moved a predefined distance away from each other and/or away from the screen. DSDM 112 is able to identify specific gestures involving a sequence of respective interactions corresponding to the initial matching signature and other matching signatures and/or matching signature segments, and in response, DSDM provides an appropriate response.

According to one or more related aspects, the first contact activates a first switch of first stylus 202 and a second switch of second stylus 212, which causes first tip 204 and second tip 214 to be communicatively coupled respectively to first barrel 206 and second barrel 216, which, in turn, are grounded via a user's hand. The dual stylus mode is initiated in response to activation of the first and second switches.

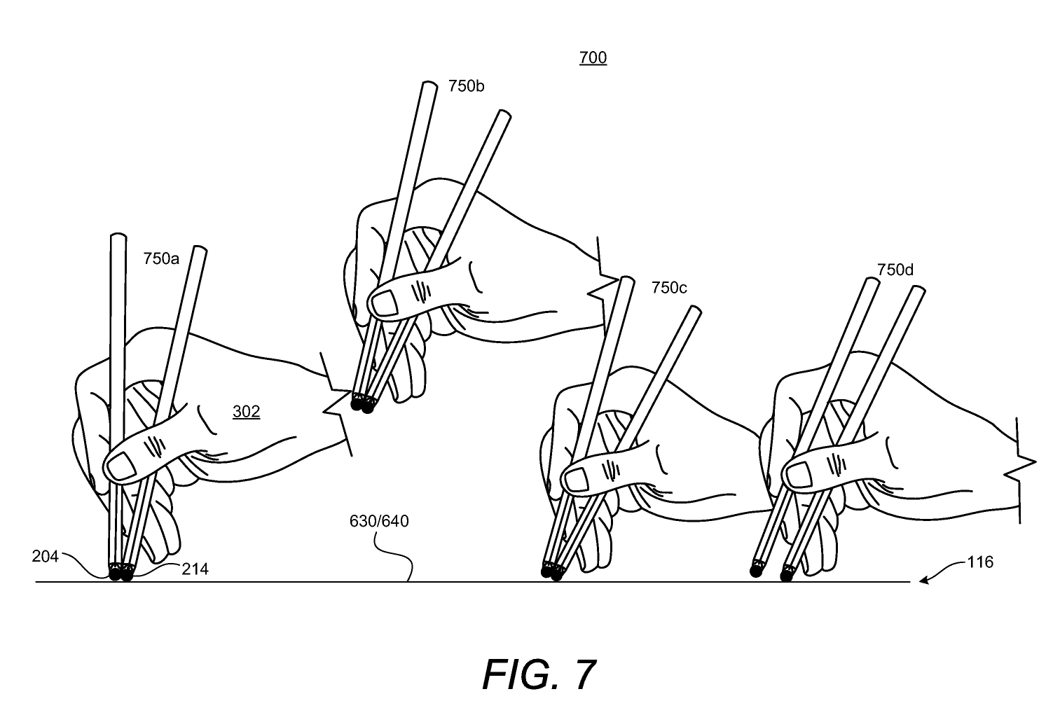

FIG. 7 illustrates a series of interactions that can represent and/or be used to identify one or more touch screen gestures, according to one or more embodiments. Interaction series 700 is performed on touch screen surface 630 by chopstick stylus apparatus 150. As illustrated, interaction series 700 includes a sequence of touch screen interactions, including a first interaction 750a corresponding to manipulation and/or an orientation of chopstick stylus apparatus 150 in a closed stylus mode at a first contact location relative to touch screen surface 630 and/or GUI (not specifically shown) displayed on touch screen surface 630, a second interaction 750b corresponding to location/orientation of chopstick stylus apparatus 150 physically separated from, but vertically above the touch screen surface 630 in a closed stylus mode, a third interaction 750c corresponding to a second contact location/orientation of chopstick stylus apparatus on touch screen surface 630 in the closed stylus mode, and a fourth interaction 750d corresponding to a contact location/orientation of chopstick stylus apparatus in an open stylus mode. In this very specific example, DSDM 112 is able to identify, using pre-established or pre-defined dual stylus operating mode, that the first interaction is a first dual-stylus, closed-touch interaction, the second interaction as a closed proximity interaction, and the third interaction as a second dual-stylus, closed-touch interaction. DSDM 112 is able to identify the fourth interaction as an individual, single stylus (or open position stylus) touch interaction using the pre-established single stylus operating mode which is activated when contact is broken between the first and second conductive tips. According to one aspect, a lower strength interaction signal is provided when the single stylus mode (which includes use of chopstick stylus apparatus 150 in open position) is activated. A higher strength interaction signal is provided when the dual stylus mode is activated. The dual stylus mode is activated when chopstick stylus apparatus is in a closed position, with the stylus tips in contact with each other. Different detection signal strengths associated with the different stylus modes correspond to respective changes in capacitance of the touch screen detection system caused by a corresponding orientation of the chopstick stylus apparatus during interaction with the touch screen.

DSDM 112 is able to identify various interactions involving both single stylus functionality and dual stylus functionality in respective single stylus mode and dual stylus mode of operation. While the single stylus mode is activated, DSDM 112 is able to identify individual touch and proximity interactions including open position stylus interactions. While the dual stylus mode is activated, DSDM 112 is able to identify various different dual stylus closed position interactions. For simplicity in describing the different types of interactions that are based on the relative positions of the tips of the first and second stylus, reference is made herein to single stylus interactions and dual stylus interactions and their respective, associated modes of operation. The single stylus interaction is used to define both interactions with a single stylus as well as interactions involving the chopstick stylus apparatus in an open position (i.e., stylus tips spaced a threshold distance apart from each other). Dual stylus interaction is then used to define interactions that involve chopstick stylus apparatus in a closed position.

According to one aspect, DSDM 112 identifies as a dual stylus interaction one of (i) a first touch interaction in which at least one of the first stylus and the second stylus maintains physical contact with the touch screen while the first tip maintains contact with the second tip and (ii) a first proximity interaction in which the first and second tips are positioned within a threshold distance above the touch screen while the first tip maintains contact with the second tip. Additionally, DSDM 112 is able to identify at least one gesture corresponding to a series of interactions that include at least one of: (a) one or more individual touch interactions; (b) the first touch interaction; (c) the first proximity interaction; and (d) one or more other closed stylus interactions. For example, DSDM 112 includes interaction series 700 within a larger set of interactions to identify a matching gesture from among one or more pre-established gestures. As an example, in one or more applications, DSDM 112 is able to identify a “pluck and hoist” gesture, which involves a sequence of interactions having an initial individual touch interaction followed by an interaction series, such as interaction series 700. Based on the at least one identified gesture, DSDM 112 performs or triggers interactive functions which involve providing corresponding changes to at least one of an associated GUI, the executing background application, and/or the electronic device.

DSDM 112 is able to identify single stylus interactions and dual stylus interactions, which collectively comprise touch interactions and proximity interactions. DSDM 112 distinguishes, using the identified touch interactions and the identified proximity interactions, between open and closed positions of the chopstick stylus apparatus within two-dimensional planes. These two-dimensional planes of the touch interactions correspond to x-y dimensions of the touch screen interface and the proximity interactions coincide with an established depth/proximity range perpendicular to a two-dimensional plane of the touch screen interface. DSDM 112 can identify at least one gesture corresponding to a series of interactions that include one or more of the identified touch interactions and proximity interactions occurring within a three-dimensional space associated with the region on the surface of and within a prescribed vertical distance above touch screen display. In addition, using the identified gesture(s), DSDM 112 performs, or triggers performance of, interactive functions which involve providing corresponding changes to at least one of an associated GUI, the background application, and the electronic device.

DSDM 112 can determine, using the received input values from touch screen sensor, that a first, single stylus touch interaction by the first stylus and a second single touch interaction by the second stylus are contemporaneously detected by the touch screen sensor. DSDM 112 identifies a gesture corresponding to the concurrently detected single touch interactions, and using the at least one identified gesture, performs, or triggers the performance of, interactive functions which involve providing corresponding changes to at least one of an associated GUI, the background application, and the electronic device.

From the received input values, DSDM 112 can determine that a detected touch interaction corresponds to a closed position provided by physical contact being maintained between the first tip and the second tip of the chopstick stylus apparatus, while at least one stylus tip is placed on the screen, as shown by third interaction 750c (FIG. 7). In the illustrative embodiment of FIG. 7, first interaction 750a illustrates both stylus tips making contact with the screen while being in contact with each other. This dual screen contact represents one embodiment of a detected touch interaction that registers as a dual stylus operation. Additionally, third interaction 750c illustrates an alternate embodiment, in which only the first stylus top makes contact with the screen, while the other stylus tip makes contact with the first stylus tip, without ever making contact with the screen. Both touch events can map to the same dual stylus operations, in one embodiment. However, a different dual stylus operation can be applied to each of the different touch events, in an alternate embodiment. The touch interaction corresponding to the closed position is identifiable via a specific signature that is associated with the dual stylus mode. In response to determining that the signature identifies detection of a closed position, DSDM 112 activates a stylus-button function (i.e., a virtual button function) that enables performance of a pre-established set of additional interactive functions with objects within the graphical user interface (GUI).

FIG. 8A illustrates a table providing detection signal information used to identify various types of touch screen interactions involving a chopstick stylus apparatus, according to a plurality of embodiments. Table 800 comprises six (6) rows including header/identifier row 812 and five (5) data rows including rows 814, 816, 818, 820 and 822. In addition, table 800 comprises five (5) columns. The information in header/identifier row 812 provides identifiers for each of the columns. For example, first column 802 is labeled as “Signal Signature” and identifies respective interaction signal signatures. Second column 804 identifies pre-established signal level ranges relative to a threshold level “T1”. The signal levels correspond to various detectable interaction signals. Third column 806 is labeled as “Identifiable Interaction Type” and identifies/classifies an interaction as a single stylus interaction signal, multiple single stylus interaction signals which includes the open position stylus interaction, and a dual stylus (closed position) interaction signal. Fourth column 808 identifies an interaction characteristic as one of a touch interaction and a proximity interaction. As presented herein, a proximity interaction is an interaction that occurs within a threshold range of (above) the touch screen and does not involve contact with the touch screen. Additionally, fifth column 810 identifies an activated chopstick stylus mode as one of a single stylus mode and a dual stylus mode.

In the specific example of table 800, first row 814 indicates that a touch screen sensor can detect an interaction signal that has a signal signature that is substantially equal to signature vector [A1]. First row 814 further indicates that the interaction signal has a signal level that is less than half the magnitude of threshold T1. In particular, the signal level ranges from 0.3*T1 to 0.4*T 1. First row 814 further indicates that the interaction signal is an individual touch interaction, which corresponds to detection of an interaction, which occurs while the chopstick stylus apparatus 150 is in the single stylus mode (e.g., open position). In addition, based on a design of the touch screen and chopstick stylus system in which an interaction type directly causes a corresponding stylus mode to be maintained or activated, at least one of the signal signature and the signal level is used to determine whether the corresponding interaction can be identified as an individual touch interaction.

Second row 816 indicates that touch screen sensor can detect an interaction signal having a signal signature that is substantially equal to signature vector [A2]. In the specific example of table 800, second row 816 further indicates that the interaction signal has a signal level that is less than 0.2*T1. Second row 816 further indicates that the interaction signal is an individual proximity interaction, which is detectable while the chopstick stylus is in the single stylus mode. In addition, at least one of the signal signature and the signal level identifies the corresponding interaction as an individual proximity interaction.

Third row 818 indicates that a touch screen sensor can detect multiple interaction signals that collectively have a signal signature that is substantially equal to signature vector [A1].sub 1+[A1].sub 2. Third row 818 further indicates that each the interaction signals has a signal level that ranges from 0.3*T1 to 0.4*T1. Third row 818 further indicates that the interaction signal corresponds to multiple individual touch interactions, which are detectable while the chopstick stylus is in the single stylus mode. In addition, at least one of the signal signature and the signal level identifies the corresponding interaction as including multiple individual touch interactions.

Fourth row 820 indicates that a touch screen sensor can detect an interaction signal that has a signal signature that is substantially equal to signature vector [B1]. Fourth row 820 also indicates that the interaction signals has a signal level that is greater than 1.5*T1. Fourth row 820 further indicates that the interaction signal corresponds to a closed stylus touch interaction which occurs while the chopstick stylus is in dual stylus mode (i.e., the closed position). In addition, based on a design of the touch screen and chopstick stylus system in which an interaction type directly causes a corresponding stylus mode to be maintained or activated, at least one of the signal signature and the signal level identifies the corresponding interaction as a closed stylus touch interaction.

Fifth row 822 indicates that a touch screen sensor can detect an interaction signal that has a signal signature which is substantially equal to signature vector [B2]. Fifth row 820 also indicates that the interaction signals has a signal level that ranges from 1.3*T1 to 1.4*T1. Fifth row 822 further indicates that the interaction signal corresponds to a closed position, dual stylus proximity interaction, which is detectable while the chopstick stylus is in the dual stylus mode. In addition, at least one of the signal signature and the signal level identifies the corresponding interaction as a closed position, dual stylus, proximity interaction.

As indicated by table 800, at least one of the signal signature and the signal level uniquely identifies the corresponding interaction. In addition, the identified interaction indicates the stylus mode as one of the single stylus mode and the dual stylus mode. As illustrated, lower signal levels (e.g., signal levels that are substantially less than threshold T1) identify a corresponding interaction as an individual interaction corresponding to the single stylus mode. Higher signal levels (e.g., signal levels that are substantially less than threshold T1) identify a corresponding interaction as a closed stylus interaction corresponding to the dual stylus mode.

As described above, the individual stylus mode enables first touch and proximity interactions identifiable as single stylus interactions to be detected via input signal levels that are below a preset threshold level. These first touch and proximity interactions, each identifiable as a single stylus interaction, can include: (a) a single touch/proximity interaction; (b) a pair of individual touch/proximity interactions occurring contemporaneously, having less than a threshold separation distance, and in which there is no electrical contact between the first and second tips, and (c) transition interactions in which there is contact between the first and second tips. These transition interactions occur prior to the dual stylus mode being activated by the contact between the first and second tips.

The dual stylus interaction mode enables detection of closed position interactions including second touch interactions and second proximity interactions. The second touch interactions are detected via first, higher signal levels, while the second proximity interactions are detected via second, lower signal levels that exceed the preset threshold level, and which is greater than a signal level corresponding to a single stylus touch interaction.

DSDM 112 is able to determine from the input values received via the touch screen sensor that a series of identified touch/proximity interactions include: (a) at least one pair of individual touch/proximity interactions occurring contemporaneously and having at least a threshold separation distance between the first tip and the second tip of the chopstick stylus apparatus; (b) at least one single individual touch interaction; and (c) the first closed stylus interaction, which follows the at least one single touch interaction. Within a specific threshold separation distance, a pair of interactions comprising contemporaneous individual touch interactions is identifiable as an individual touch interaction via the single touch mode. In addition, an interaction involving contact between the first tip and the second tip is identifiable as an individual touch interaction while the single stylus mode remains active and before the contact activates the dual stylus mode.

In one embodiment, a characteristic in a design of the touch screen sensing system causes multiple individual interactions that are spatially separated by less than a threshold separation distance to be identified as a single individual interaction. Similarly, design characteristics of the touch screen sensing system causes a transition interaction to be identified as a single individual interaction.

FIG. 8B illustrates a table providing a mapping of identified touch screen interactions involving a chopstick stylus apparatus to gesture definitions and functional responses, according to one or more embodiments. The detected interactions are identified by DSDM 112 as specific gestures (by mapping within the table, for example) based on the signal values (strength and type) and interaction data received from touch screen sensor. Table 850 comprises six (6) rows including header/identifier row 860 and five (5) data rows including rows 862, 864, 866, 868 and 870. In addition, table 850 comprises four (4) columns. The information in header/identifier row 860 provides identifiers for each of the columns. For example, first column 852 is labeled as “Identified Interaction” and identifies identifiable touch screen interactions in respective rows. Second column 854 identifies an operation P that is performed when a corresponding gesture comprising one or more interactions is identified. Third column 856 identifies an operation Q that is performed when a corresponding gesture comprising one or more interactions is identified. Fourth column 858 identifies an operation R that is performed when a corresponding gesture comprising one or more interactions is identified. It is appreciated that these operations are programmable responses that map to detection of specific interactions or sequence of interactions by both a single stylus and by dual stylus apparatus 150.

In the specific example of table 850, second column 854 indicates that gesture X comprises a sequence of interactions which include (a) an open stylus interaction which occurs first in the sequence of interactions as indicated by X1, (b) an individual touch interaction which occurs second in the sequence of interactions as indicated by X2, and (c) a closed stylus touch interaction which occurs third in the sequence of interactions as indicated by X3. As indicated in second column 854, DSDM 112 triggers an execution of operation P, which is performed in response to identifying an occurrence of gesture X.

Third column 856 indicates that gesture Y comprises a sequence of interactions which include (a) a closed stylus proximity interaction which occurs first in the sequence of interactions as indicated by Y1, (b) a closed stylus touch interaction which occurs second in the sequence of interactions as indicated by Y2, and (c) an individual touch interaction which occurs third in the sequence of interactions as indicated by Y3. As indicated in third column 856, DSDM 112 triggers an execution of operation Q, which is performed in response to identifying an occurrence of gesture Y.

Fourth column 858 indicates that gesture Z comprises a single interaction which is identified as a closed stylus touch interaction as indicated by Z. As indicated in fourth column 858, DSDM 112 triggers an execution of operation R, which is performed in response to identifying an occurrence of gesture Z.

According to one or more aspect, DSDM 112 identifies at least one gesture corresponding to a series of interactions that include closed stylus interactions associated with dual stylus mode and these types of identified touch interactions associated with the single stylus mode. Furthermore, DSDM 112 performs, using the at least one identified gesture, interactive functions which involve providing corresponding changes to at least one of an associated GUI and the electronic device.

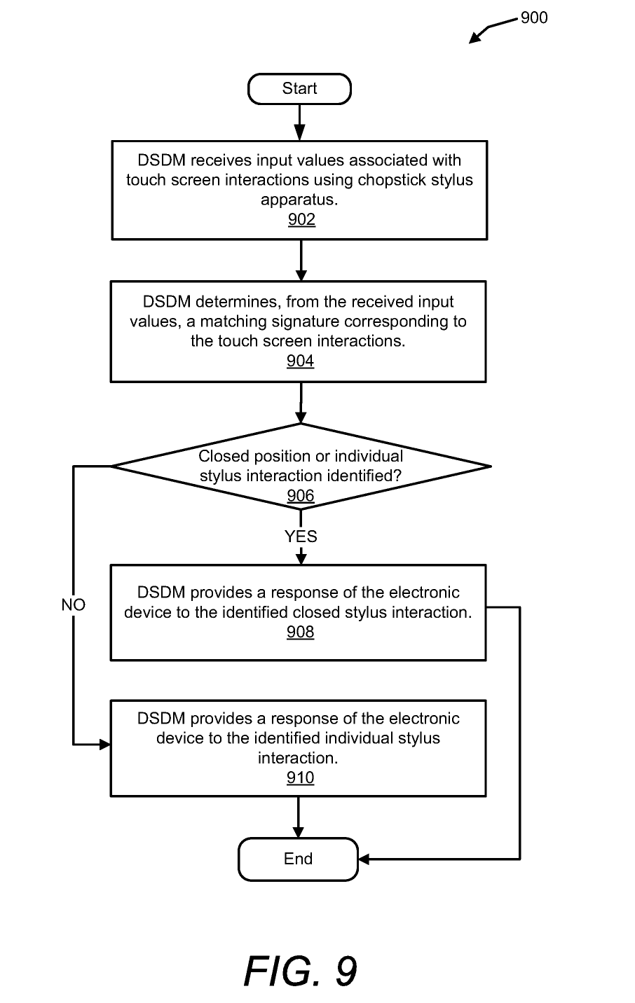

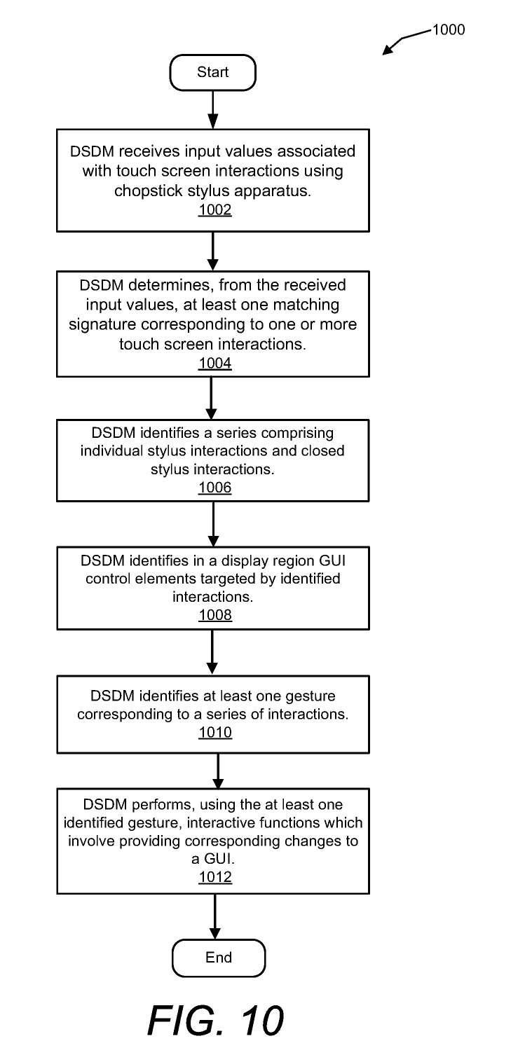

FIGS. 9-10 presents flowcharts illustrating example methods by which IHS 100 and specifically processor 102 executing functional code of DSDM 112 presented within the preceding figures perform different aspects of the processes that enable one or more embodiments of the disclosure. Method 900 represents a method for identifying single stylus and dual stylus interactions based on an interaction signal signature within touch screen and chopstick stylus (TSCS) system 600. Method 1000 represents a method for performing responsive gestures within a GUI based on identifying single stylus and dual stylus interactions. The description of each method is provided with general reference to the specific components illustrated within the preceding figures. It is appreciated that certain aspects of the described methods may be implemented via other processing devices and/or execution of other code/firmware. In the discussion of FIGS. 9-10, reference is also made to elements described in FIGS. 1-8.

The method processes are performed by execution of DSDM 112 by processor 102, and are generally described as functions performed by DSDM 112, for simplification of the description. With reference to FIG. 9, method 900 begins at the start block and proceeds to block 902 at which processor 102/DSDM 112 receives input values associated with touch screen interactions using chopstick stylus apparatus. DSDM 112 determines, from the received input values, a matching signature corresponding to the touch screen interactions (block 904). DSDM 112 determines whether a dual stylus (closed position) interaction (i.e., as opposed to an individual stylus (e.g., an open position) interaction is identified (decision block 906). As previously described, detection of a closed position (touch/proximity) interaction maintains or activates the dual stylus mode, which triggers corresponding dual stylus functionality, and detection of a single stylus or open position (touch/proximity) interaction maintains or activates the single stylus mode, with corresponding single stylus functionality. Furthermore, an active dual stylus mode enables detected touch/proximity interactions to be correctly identified as closed position interactions and responded to by an associated operation mapped to the specific interaction. An active single stylus mode enables selected types of detected touch/proximity interactions to be identified and responded to as a single stylus interaction(s). If DSDM 112 determines that a closed stylus interaction is identified, DSDM 112 provides a specific pre-programmed response of the electronic device to the identified closed stylus interaction (block 908). If DSDM 112 determines that a closed stylus interaction is not identified, DSDM 112 provides a response of the electronic device to the identified individual stylus interaction (block 910). The process concludes at the end block.

Referring now to FIG. 10, method 1000 begins at the start block and proceeds to block 1002 at which processor 102/DSDM 112 receives input values associated with touch screen interactions by chopstick stylus apparatus. DSDM 112 determines, from the received input values, at least one matching signature corresponding to one or more touch screen interactions (block 1004). DSDM 112 identifies a series comprising individual touch/proximity interactions (e.g., open stylus interactions) and closed position stylus touch/proximity interactions (block 1006). DSDM 112 identifies, in a target display region within a graphical user interface (GUI), one or more control elements targeted by the identified interactions (block 1008). DSDM 112 identifies at least one matching gesture corresponding to the identified series of interactions associated with the target display region (block 1010). DSDM 112 performs, based on the at least one identified gesture, one or more functions, which can involve implementing corresponding changes to GUI (block 1012). The process concludes at the end block.

In the above described flow charts, one or more of the methods may be embodied in a computer readable device containing computer readable code such that a series of functional processes are performed when the computer readable code is executed on a computing device. In some implementations, certain steps of the methods are combined, performed simultaneously or in a different order, or perhaps omitted, without deviating from the scope of the disclosure. Thus, while the method blocks are described and illustrated in a particular sequence, use of a specific sequence of functional processes represented by the blocks is not meant to imply any limitations on the disclosure. Changes may be made with regards to the sequence of processes without departing from the scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object oriented programming language, without limitation. These computer program instructions may be provided to a processor of a general purpose computer, special purpose computer, such as a service processor, or other programmable data processing apparatus to produce a machine, such that the instructions, which execute via the processor of the computer or other programmable data processing apparatus, performs the method for implementing the functions/acts specified in the flowchart and/or block diagram block or blocks.

As will be further appreciated, the processes in embodiments of the present disclosure may be implemented using any combination of software, firmware or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible medium that can contain, or store a program for use by or in connection with an instruction execution system, apparatus, or device.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A chopstick stylus apparatus comprising:
a first stylus having a first tip, a first barrel that can be grounded via a user's hand, and a first switch that enables the first tip to be communicatively coupled to the first barrel; and
a second stylus having a second tip, a second barrel that can be grounded via a user's hand, and a second switch that enables the second tip to be communicatively coupled to the second barrel;
wherein the first stylus and the second stylus are operable together by a user using a single hand to provide single stylus functionality and dual stylus functionality based on user manipulation.

2. The chopstick stylus apparatus of claim 1, wherein:
the first switch is capacitively coupled to the first tip, and the second switch is capacitively coupled to the second tip;
each of the first switch and the second switch is activated by contact being made between the first tip and the second tip in response to the first tip and the second tip being moved toward each other;
the first tip is communicatively coupled to the first barrel of the first stylus in response to the first switch being activated;
the second tip is communicatively coupled to the second barrel of the second stylus in response to the second switch being activated;
single stylus mode is detected in response to individual and open stylus touch screen interactions that generate first, lower signal levels;
a dual stylus mode is activated in response to the first switch and the second switch being activated; and
a dual stylus mode is detected in response to dual, closed stylus touch screen interactions that generate second, higher signal levels.

3. The chopstick stylus apparatus of claim 1, wherein:
the first switch includes a first elastomeric connector that is capacitively coupled by a first connector node to the first tip, and which is also electrically coupled by a second connector node to the first barrel;
the second switch includes a second elastomeric connector that is capacitively coupled by a third connector node to the second tip, and which is also electrically coupled by a fourth connector node to the second barrel;
the first elastomeric connector having first conductive layers that are exposed on a corresponding stylus surface and the second elastomeric connector having second conductive layers that are exposed on a corresponding stylus surface, wherein the first elastomeric connector is a complementary component of the second elastomeric connector;
in response to contact being made between the first conductive layers and the second conductive layers, the first connector node becomes electrically coupled to the second connector node and the first barrel, and the third connector node becomes electrically coupled to the fourth connector node and the second barrel; and
the dual stylus mode is activated in response to the electrical coupling involving respective connector nodes.

4. The chopstick stylus apparatus of claim 1, wherein:
the first switch includes a first diode that is electrically coupled by a first anode or positive electrode to the first tip and is electrically coupled by a first cathode or negative electrode to the first barrel;
the second switch includes a second diode that is electrically coupled by a second cathode or negative electrode to the second tip and is electrically coupled by a second anode or positive electrode to the second barrel;
the first diode and the second diode are collectively arranged in a reverse parallel configuration when the first switch and second switch are activated by contact being made between the first and second tips; and
the dual stylus mode is activated in response to the first switch and the second switch being activated by contact being made between the first and second tips.

5. A touch screen and chopstick-stylus system comprising:
a chopstick stylus apparatus including a first stylus and a second stylus, each stylus having a conductive tip, a barrel that can be grounded by a user's single hand, and a switch that enables the conductive tip to be communicatively coupled to the barrel, wherein the chopstick stylus system is operable by a user using the single hand to provide individual stylus functionality and dual stylus functionality based on user manipulation;
an electronic device having:
a processor;
a capacitive touch screen display communicatively coupled to the processor and which is configured to detect touch and proximity interactions with the chopstick stylus apparatus, the capacitive touch screen display having a touch screen sensor that collects information corresponding to the detected touch and proximity interactions by the chopstick stylus apparatus and forwards the information to the processor; and
a dual stylus detection module (DSDM) executing on the processor, which enables the processor and the electronic device to support both the single stylus and the dual stylus functions of the chopstick stylus apparatus, wherein the processor:
receives input values from the information representing the touch screen interactions;
determines, from the received input values, at least one matching signature from among a plurality of interaction signatures corresponding to different touch screen interactions that can be provided via the chopstick stylus apparatus; and
provides a response of the electronic device to at least one identified touch screen interaction based on the at least one matching signature.

6. The system of claim 5, wherein the received input values comprises location information identifying a display region at which an interaction is detected, and the processor:
identifies, based on the identified display region, at least one control element within a graphical user interface (GUI), which control element is being targeted by at least one identified interaction with the touch screen;
identifies at least one matching gesture associated with the at least one identified interaction within the identified display region;
wherein in providing said response of the electronic device, the processor performs interactive functions that include providing corresponding changes to the GUI of the touch screen display utilizing said at least one matching gesture.

7. The system of claim 5, wherein:
the processor identifies a type of interaction corresponding to received input values from the touch screen sensor based on at least one of a signal level and an interaction signature corresponding to the received input values;
the at least one matching signature comprises a first matching signature; and
the processor determines that the first matching signature represents a first closed stylus interaction caused by a first contact being made between the first stylus and the second stylus, wherein the first contact activates the dual stylus mode which enables the chopstick stylus apparatus to be operable to provide at least one closed stylus interaction having an identifiable signature associated with the activated dual stylus mode.

8. The system of claim 7, wherein;
the at least one matching signature comprises an initial matching signature;
the processor determines from the initial matching signature that a touch event which is identified as an individual touch interaction involving a single one of the first stylus and the second stylus has occurred, the individual touch interaction being associated with and being identifiable via the individual stylus mode, wherein the identified individual touch interaction precedes the closed stylus interaction, wherein the dual stylus interaction mode which remains activated while contact is maintained between the first tip and the second tip enables detection of closed stylus interactions.

9. The system of claim 7, wherein:
the first contact activates a first switch of the first stylus and a second switch of the second stylus, which causes the first tip and the second tip to be respectively communicatively coupled to a first barrel and a second barrel that are coupled to ground via a user's hand; and
wherein activation of the first and second switches initiates the dual stylus mode.

10. The system of claim 7, wherein the processor:
determines that the first closed stylus interaction comprises (i) a first touch interaction in which at least one of the first stylus and the second stylus maintains physical contact with the touch screen while the first tip maintains contact with the second tip and (ii) a first proximity interaction in which the first and second tips are positioned within a threshold distance above the touch screen while the first tip maintains contact with the second tip;
identifies at least one gesture corresponding to a series of interactions that include at least one of: (a) one or more individual touch interactions; (b) the first touch interaction; (c) the first proximity interaction; and (d) one or more other closed stylus interactions; and
performs, using the at least one identified gesture, interactive functions which involve providing corresponding changes to at least one of an associated GUI and the electronic device.

11. The system of claim 7, wherein:
the individual stylus mode enables first touch and proximity interactions identifiable as single stylus interactions to be detected via input signal levels that are below a preset threshold level, wherein the first touch and proximity interactions, each identifiable as a single stylus interaction, include: (a) a single touch/proximity interaction; (b) a pair of individual touch/proximity interactions occurring contemporaneously, having less than a threshold separation distance, and in which there is no electrical contact between the first and second tips, and (c) transition interactions in which there is contact between the first and second tips and which transition interactions occur prior to the dual stylus mode being activated by said contact, wherein the dual stylus interaction mode enables detection of closed stylus interactions including second touch interactions and second proximity interactions, which are respectively detected via first, higher signal levels and second, lower signal levels that exceed the preset threshold level which is greater than a signal level corresponding to a single stylus touch interaction.

12. The system of claim 7, wherein the processor:
determines from the received input values that a series of identified touch/proximity interactions include: (a) at least one pair of individual touch/proximity interactions occurring contemporaneously and having at least a threshold separation distance between the first tip and the second tip of the chopstick stylus apparatus; (b) at least one single individual touch interaction; and (c) the first closed stylus interaction, which follows the at least one single touch interaction; wherein a pair of interactions comprising contemporaneous individual touch interactions which occur within the threshold separation distance are identifiable as an individual touch interaction, wherein an interaction involving contact between the first tip and the second tip is identifiable as an individual touch interaction while the single stylus mode remains active and before the contact activates the dual stylus mode;
identifies at least one gesture corresponding to a series of interactions that include closed stylus interactions associated with dual stylus mode and identified touch interactions associated with the single stylus mode; and
performs, using the at least one identified gesture, interactive functions which involve providing corresponding changes to at least one of an associated GUI and the electronic device.

13. The system of claim 7, wherein the processor:
identifies single stylus interactions and dual stylus interactions, which collectively comprise touch interactions and proximity interactions;
distinguishes, using the identified touch interactions and proximity interactions, between open and closed positions of the chopstick stylus apparatus within two-dimensional planes corresponding to x-y dimensions of the touch screen interface and coinciding with an established depth range perpendicular to a two-dimensional plane of the touch screen interface;
identifies at least one gesture corresponding to a series of interactions that include one or more of the identified touch interactions and proximity interactions associated with a three-dimensional space associated with the touch screen display; and
performs, using the at least one identified gesture, interactive functions which involve providing corresponding changes to at least one of an associated GUI and the electronic device.

14. The system of claim 5, wherein the processor:
determines, using the received input values, that a first single touch interaction by the first stylus and a second single touch interaction by the second stylus are contemporaneously detected by the touch screen sensor;
identifies a gesture corresponding to the concurrently detected single touch interactions; and
performs, using the at least one identified gesture, interactive functions which involve providing corresponding changes to at least one of an associated GUI and the electronic device.

15. The system of claim 5, wherein the processor:
determines from the received input values that a touch interaction corresponding to a closed position is provided by physical contact being maintained between the first tip and the second tip of the chopstick stylus apparatus;
wherein the touch interaction corresponding to maintaining the closed position is identifiable via a signature associated with the dual stylus mode; and
in response to determining that the maintained closed position is detected, activates a stylus-button function that enables performance of a pre-established set of additional interactive functions responsive to selected interactions between the chopstick stylus apparatus and objects within the graphical user interface (GUI).

16. A method comprising:
receiving, from a touch screen sensor, input values representing information associated with interactions of a chopstick stylus apparatus detected via a touch screen display of an electronic device;
determining, from the received input values, at least one matching signature from among a plurality of signatures corresponding to different touch screen interactions that can be provided using the chopstick stylus apparatus; and
providing, using said at least one matching signature, a response of the electronic device to at least one identified touch screen interaction involving the chopstick stylus apparatus.

17. The method of claim 16, wherein the received input values comprises location information identifying a display region at which an interaction is detected, the method further comprising:
identifying, based on the identified display region, at least one control element within a graphical user interface (GUI), which control element is being targeted by at least one identified interaction with the touch screen;
identifying at least one matching gesture associated with the at least one identified interaction within the identified display region; and
wherein in providing said response of the electronic device, the processor performs interactive functions that include providing corresponding changes to the GUI of the touch screen display utilizing said at least one matching gesture.

18. The method of claim 16, further comprising:
identifying a type of interaction corresponding to received input values from the touch screen sensor based on at least one of a signal level and an interaction signature corresponding to the received input values;
determining that an interaction corresponding to a first matching signature is a first closed stylus interaction involving contact being made between the first stylus and the second stylus, wherein the contact activates the dual stylus mode which enables the chopstick stylus apparatus to be operated to provide a closed stylus interaction having an identifiable signature associated with the activated dual stylus mode; and
wherein the received input values include first input values, and the at least one matching signature includes the first matching signature corresponding to the first input values.
